(19) United States
(12) Patent Application Publication
(10) Pub. No.: US 2007/0268187 A1
(43) Pub. Date: Nov. 22, 2007

(54) Inverted-F antenna and manufacturing method thereof

(75) Inventor: Shih-Chieh Cheng, Tainan County (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/598,696

(22) Filed: Nov. 14, 2006

(30) Foreign Application Priority Data
May 19, 2006 (TW) 095117921

(51) Int. Cl. H01Q 1/38

(52) U.S. Cl. 343/700 MS; 343/702

(57) ABSTRACT

An inverted-F antenna includes a first radiating portion, a second radiating portion, a grounding portion and a feeding portion. The first radiating portion is extended from one side of the grounding portion. The second radiating portion is extended from the side of the grounding portion, and has one side opposite to the side of the grounding portion. The feeding portion is extended from the side of the second radiating portion. In addition, a manufacturing method of the inverted-F antenna is disclosed.

### BACKGROUND OF THE INVENTION

1. Field of Invention

The invention relates to an antenna and a manufacturing method thereof, and, in particular, to an inverted-F antenna and a manufacturing method thereof.

2. Related Art

The rapidly developed radio transmission has brought various products and technologies applied in the field of multi-band transmission, such that many new products have the performance of radio transmission to meet the consumer's requirement. The antenna is an important element for transmitting and receiving electromagnetic wave energy in the radio transmission system. If the antenna is lost, the radio transmission system cannot transmit and receive data. Thus, the antenna plays an indispensable role in the radio transmission system.

Selecting a proper antenna can match the feature of the product, enhance the transmission property, and further reduce the product cost. Different methods and different materials for manufacturing the antennas are used in different application products. In addition, considerations have to be taken when the antenna is designed according to different frequency bands used in different countries. The commonly used specifications of frequency band include IEEE 802.11, the most popular bluetooth communication (IEEE 802.15.1), and the like. IEEE 802.11 is further divided into 802.11a, 802.11b and 802.11g, wherein the 802.11a specification corresponds to the frequency band of 5 GHz, and the 802.11b and 802.11g specifications correspond to the frequency band of 2.4 GHz. The bluetooth works at the frequency band of 2.4 GHz.

The commonly used antennas include monopole antennas, inverted-F antennas, and dipole antennas. Because the inverted-F antenna may be manufactured easily and has a small size, it is widely used in mobile communication apparatuses, such as mobile phones, personal digital assistants (PDAs), and other devices.

Referring to FIGS. 1A to 1D, the method of manufacturing a conventional inverted-F antenna includes steps 1 to 7.

As shown in FIG. 1A, step 1 provides a metal sheet 1 having a long side 11, a short side 12 and another long side 11′ parallel to the long side 11.

As shown in FIG. 1B, step 2 forms a first slit 13, which is parallel to the short side 12, from the long side 11 of the metal sheet 1. Next, step 3 forms a second slit 14, which is parallel to the first slit 13 and has the same length as the first slit 13, from the long side 11 of the rectangular metal sheet 1. The region between the first slit 13 and the second slit 14 is defined as a feeding portion 21. Then, step 4 forms a third slit 15, which is connected to one end of the first slit 13, from the short side 12 of the metal sheet 1, and removes one portion 16 of the metal sheet. Step 5 forms a fourth slit 17, which is connected to one end of the second slit 14, from another short side 12′ parallel to the short side 12 of the metal sheet 1, and removes another portion 18 of the metal sheet.

Next, as shown in FIG. 1C, a region formed by the short side 12 of the metal sheet and a line distant from the short side 12 by a distance D is defined as a grounding portion 22, and the region exclusive of the grounding portion 22 and the feeding portion 21 is defined as a radiating portion 23.

As shown in FIG. 1D, step 6 bends the feeding portion 21 by 90 degrees along a direction parallel to the long side 11′, and bends the grounding portion 22 by 90 degrees along a direction parallel to the short side 12. Finally, step 7 arranges a printed circuit board 24 in parallel with the radiating portion 23, and electrically connects the printed circuit board 24 to the feeding portion 21 and the grounding portion 22 to complete the manufacturing of the inverted-F antenna.

However, the portions 16 and 18 of the metal sheet, which are removed in the method of manufacturing the inverted-F antenna and are referred to as metal waste products (see FIG. 1B), occupy about 20 to 35% of the metal sheet. In other words, the effectively used region of the metal sheet 1 only reaches the ratio of 65 to 80%, and the other portions are wasted. Thus, the material cost is increased, and the manufacturing processes are complicated because the first slit 13, the second slit 14, the third slit 15 and the fourth slit 17 have to be formed by four cutting processes. Furthermore, the stresses caused by the cutting processes at the connection portion C1 (FIG. 1B) between the first slit 13 and the third slit 15 and the connection portion C2 (FIG. 1B) between the second slit 14 and the fourth slit 17 tend to cause the feeding portion 21 to be damaged or broken after being bent or used for a long time.

Thus, it is an important subject of the invention to provide an inverted-F antenna and a method of manufacturing the same in order to reduce the ratio of the metal waste products to the metal sheet and to simplify the manufacturing processes.

### SUMMARY OF THE INVENTION

In view of the foregoing, the invention is to provide an inverted-F antenna having a feeding portion, which cannot be easily broken, and a method of manufacturing the inverted-F antenna with an enhanced availability of the metal sheet and simplified manufacturing processes.

To achieve the above, the invention discloses an inverted-F antenna including a first radiating portion, a second radiating portion, a grounding portion and a feeding portion. The first radiating portion is extended from one side of the grounding portion. The second radiating portion is extended from the one side of the grounding portion and has one side opposite to the side of the grounding portion. The feeding portion is extended from the side of the second radiating portion.

To achieve the above, the invention also discloses a method of manufacturing an inverted-F antenna. The method includes the steps of: providing a metal sheet having a first side, a second side and a third side opposite to the first side; forming a first slit from the first side of the metal sheet to the third side; forming a second slit from the second side of the metal sheet to the first slit, and removing a portion of the metal sheet; defining a region formed by the first slit, the second slit and the second side, as a feeding portion, and bending the feeding portion by a first angle along a direction parallel to the third side; and defining a region formed by the third side and a line distant from the third side by a distance, as a grounding portion, and bending the grounding portion by a second angle along a direction parallel to the third side.

As mentioned above, only two slits including the first slit and the second slit are formed in the inverted-F antenna and the manufacturing method thereof according to the invention. Compared with the prior art in which four slits are formed, the manufacturing processes of the invention are further simplified. In addition, the bending portion of the feeding portion only contacts one end of the first slit. Compared with the prior art, in which the bending portion of the feeding portion contacts the connection portion between the first slit and the third slit, and the connection portion between the second slit and the fourth slit, the feeding portion of the inverted-F antenna of the invention cannot be easily influenced by cutting or bending stress. Furthermore, the removed portion of the metal sheet of the invention occupies about 8 to 10% of the overall metal sheet. In other words, the effectively used region of the metal sheet can reach a ratio of about 90 to 92%. Compared with the prior art, in which the effectively used region only reaches a ratio of 65 to 80%, the inverted-F antenna of the invention makes more efficient use of the metal sheet.

### BRIEF DESCRIPTION OF THE DRAWINGS

The invention will become more fully understood from the detailed description given herein below illustration only, and thus is not limitative of the present invention, and wherein:

FIGS. 1A to 1D are flow charts showing a conventional method of manufacturing an inverted-F antenna;

FIG. 2 is a pictorial view showing an inverted-F antenna according to a preferred embodiment of the invention;

FIG. 3 is a flow chart showing a method of manufacturing the inverted-F antenna according to the preferred embodiment of the invention; and

FIGS. 4A to 4F are pictorial views showing the inverted-F antenna at different steps in the manufacturing process the inverted-F antenna according to FIG. 3.

### DETAILED DESCRIPTION OF THE INVENTION

The present invention will be apparent from the following detailed description, which proceeds with reference to the accompanying drawings, wherein the same references relate to the same elements.

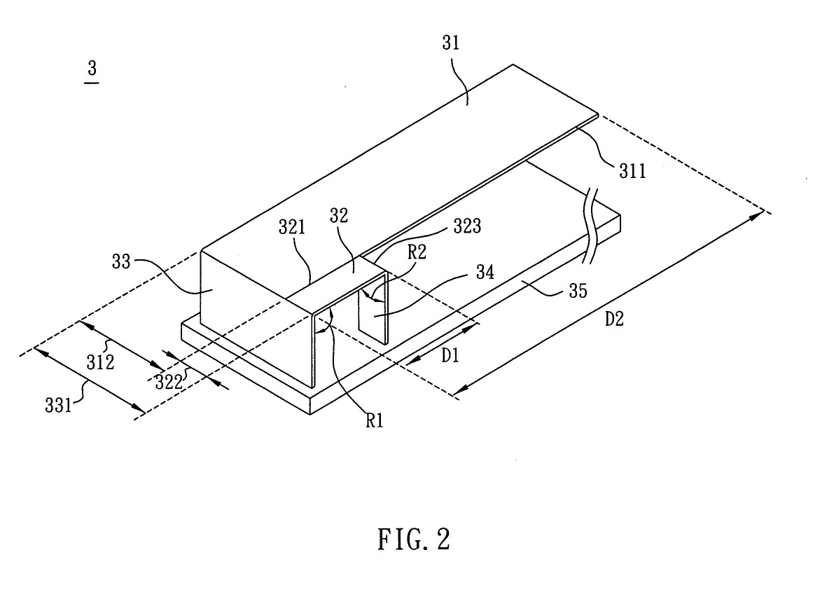

Referring to FIG. 2, an inverted-F antenna 3 according to the preferred embodiment of the invention includes a first radiating portion 31, a second radiating portion 32, a grounding portion 33 and a feeding portion 34.

The first radiating portion 31 is extended from one side 331 of the grounding portion 33 and has a first side 311 and a second side 312. The second side 312 of the first radiating portion 31 is extended from the one side 331 of the grounding portion 33. In addition, the shape of the first radiating portion 31 can be modified according to the actual requirement. In this embodiment, the first radiating portion 31 is a roughly rectangular sheet.

The second radiating portion 32 is extended from the one side 331 of the grounding portion 33 and has a third side 321, a fourth side 322 and one side 323 (hereinafter referred to as a fifth side 323) opposite to the one side 331 of the grounding portion 33. The fourth side 322 of the second radiating portion 32 is extended from the one side 331 of the grounding portion 33. In this embodiment, the second side 312 of the first radiating portion 31 is connected to the fourth side 322 of the second radiating portion 32. In addition, the length of the fourth side 322 of the second radiating portion 32 is smaller than the length of the second side 312 of the first radiating portion 31. Furthermore, the second side 312 of the first radiating portion 31 and the fourth side 322 of the second radiating portion 32 form an angle of 180 degrees. That is, the second side 312 of the first radiating portion 31 and the fourth side 322 of the second radiating portion 32 are located on the same plane.

In addition, the first side 311 of the first radiating portion 31 is extended from the third side 321 of the second radiating portion 32. The shaped of the second radiating portion 32 may be modified according to the actual requirement. In this embodiment, the second radiating portion 32 is also a roughly rectangular sheet. Furthermore, a length D1 of the third side 321 of the second radiating portion 32 is smaller than a length D2 of the first side 311 of the first radiating portion 31 such that the first radiating portion 31 and the second radiating portion 32 form a roughly L-shaped sheet. In addition, the third side 321 of the second radiating portion 32 in this embodiment is a portion of the first side 311 of the first radiating portion 31. In other words, the first radiating portion 31 and the second radiating portion 32 are integrally formed.

The shape of the grounding portion 33 may be modified according to the actual requirements. In this embodiment, the grounding portion 33 is a roughly rectangular sheet. In addition, each of the first radiating portion 31 and the second radiating portion 32 is extended from the one side 331 of the grounding portion 33 and forms an angle R1 with the grounding portion 33. The angle R1 may be modified according to the actual requirement. In this embodiment, the angle R1 is equal to 90 degrees.

The feeding portion 34 is extended from the fifth side 323 of the second radiating portion 32. The shape of the feeding portion 34 may be modified according the actual requirement. In this embodiment, the feeding portion 34 is a slightly rectangular sheet. In addition, the feeding portion 34 forms an angle R2 with the second radiating portion 32 and is extended from the fifth side 323 of the second radiating portion 32. The angle R2 may be modified according to the actual requirement. In this embodiment, the angle R2 is also equal to 90 degrees.

In this embodiment, the first radiating portion 31, the second radiating portion 32, the grounding portion 33 and the feeding portion 34 are each made of metal, and the first radiating portion 31, the second radiating portion 32, the grounding portion 33 and the feeding portion 34 are integrally formed.

In addition, the inverted-F antenna 3 further includes a base plate 35, which faces the first radiating portion 31 and the second radiating portion 32 and is electrically connected with the grounding portion 33 and the feeding portion 34. In this embodiment, the base plate 35 is substantially parallel to the first radiating portion 31 and the second radiating portion 32. In addition, the substrate 14 of this embodiment can be a printed circuit board (PCB) made of bismaleimide-triazine resin (BT resin) or fiberglass reinforced epoxy resin (FR4), a flexible film substrate made of polyimide, or even be integrated as part of a circuit board to save space.

It is to be noted that the inverted-F antenna 3 may be operated in different frequency bands according to the actual design, in which the first radiating portion 31 and the second radiating portion 32 are designed into different shapes and patterns. The frequency bands may include the frequency bands of a GSM (Global System for Mobile communication) specification, a GPRS (General Packet Radio Service) specification, a DECT (Digital Enhanced Cordless Telecommunication) specification or an IEEE802.11 specification or other frequently used frequency bands. Of course, the antenna may also be configured to operate in a dual-band or a multi-band mode according to the actual requirement, and detailed descriptions thereof will be omitted.

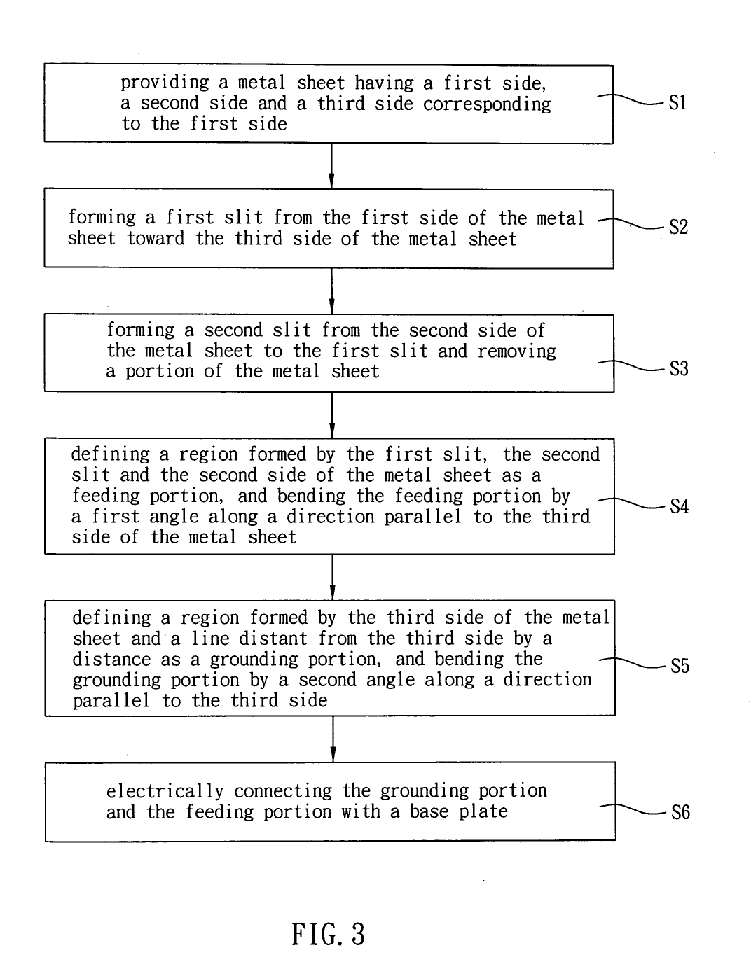

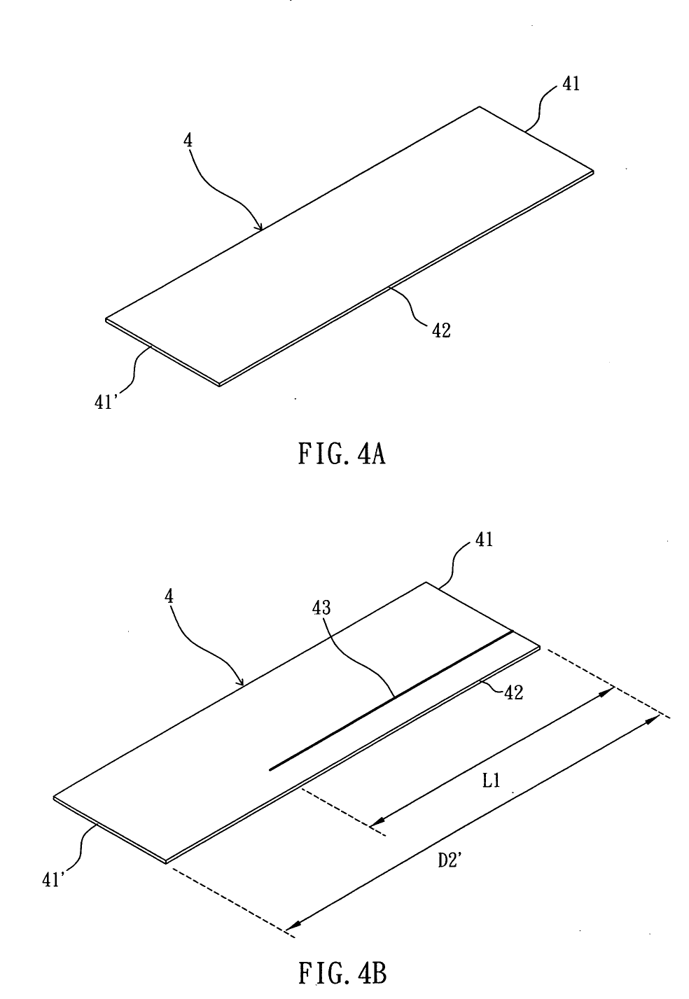

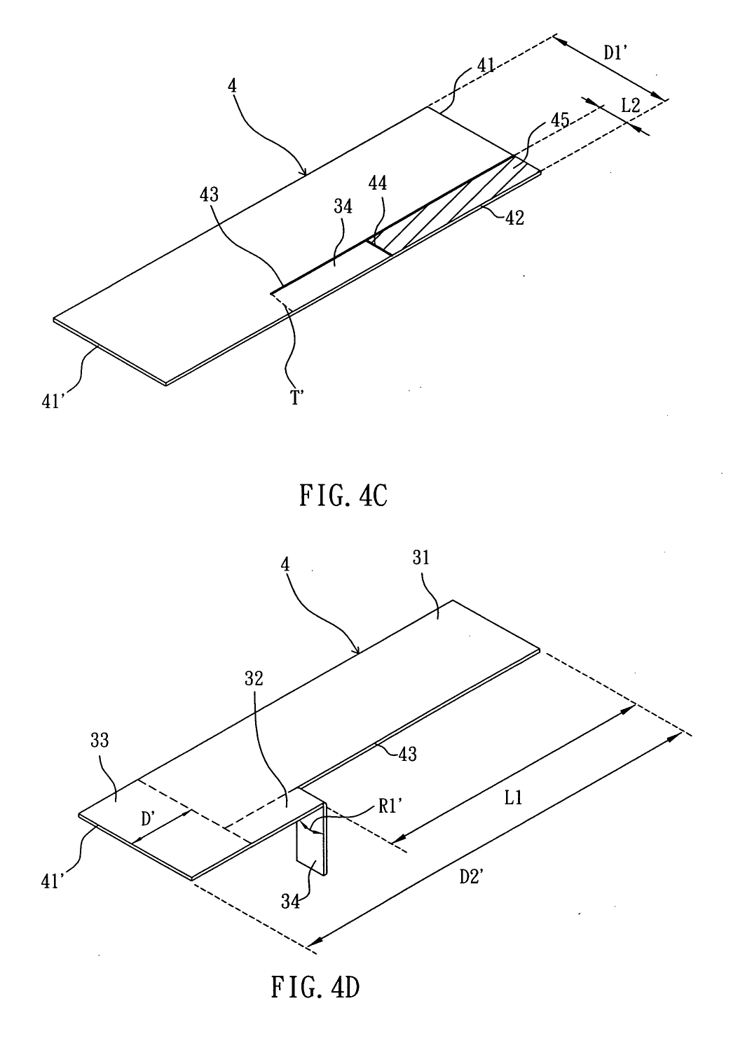

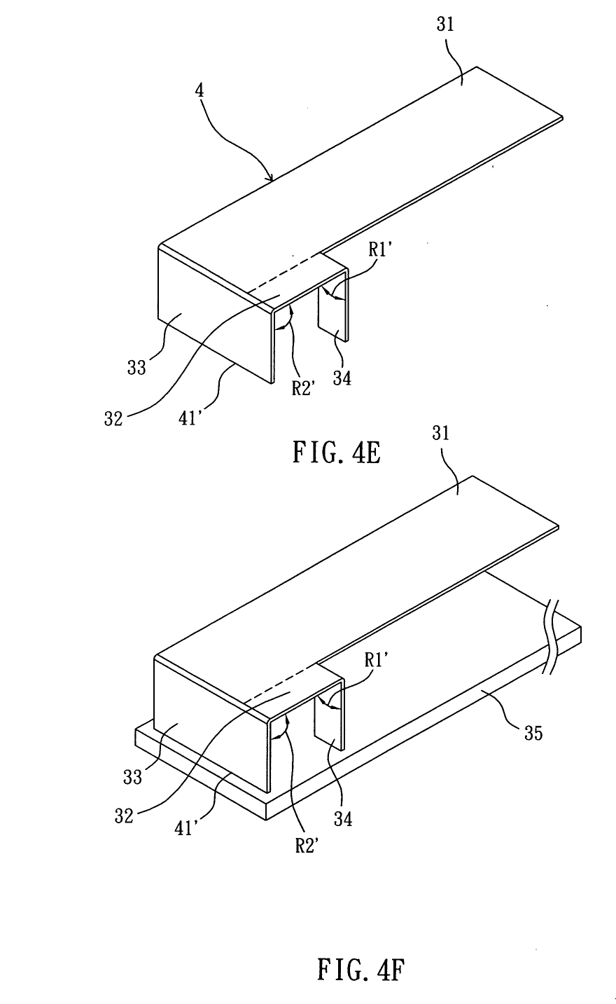

In order to make the invention clearer, a method of manufacturing the inverted-F antenna will be described by way of example. Please refer simultaneously to FIGS. 3 and 4A to 4F. FIGS. 4A to 4F are pictorial views showing the inverted-F antenna at different steps of the manufacturing process the inverted-F antenna according to FIG. 3.

As shown in FIG. 4A, step S1 provides a metal sheet 4 having a first side 41, a second side 42 and a third side 41′ corresponding to the first side 41. In this embodiment, the metal sheet 4 is a rectangle.

As shown in FIG. 4B, step S2 forms a first slit 43 from the first side 41 of the metal sheet 4 toward the third side 41′ of the metal sheet 4. In this embodiment, the first slit 43 may be formed by way of cutting or cropping. In addition, the first slit 43 is substantially parallel to the second side 42 of the metal sheet 4 in this embodiment, and the length L1 of the first slit 43 is smaller than the length D2′ of the second side 42 of the metal sheet 4.

As shown in FIG. 4C, step S3 forms a second slit 44 from the second side 42 of the metal sheet 4 to the first slit 43 and removes a portion 45 of the metal sheet, wherein one end of the second slit 44 is connected to the first slit 43. The portion 45 of the metal sheet removed in this invention occupies about 8 to 10% of the overall metal sheet 4. in other words, the effectively used region of the metal sheet 4 reaches a ratio of about 90 to 92%. Compared with the effectively used region of the prior art, which only reaches the ratio of about 65 to 80%, the invention uses a higher proportion of the metal sheet 4.

In this embodiment, the second slit 44 may also be formed by way of cutting or cropping and is substantially perpendicular to the first slit 43, and the length L2 of the second slit 44 is smaller than the length D1′ of the first side 41. Because the method of forming the inverted-F antenna 3 of the invention only forms the first slit 43 and the second slit 44, the manufacturing processes of the invention is simpler compared with the prior art in which four slits are formed.

As shown in FIGS. 4C and 4D, step S4 defines a region formed by the first slit 43, the second slit 44 and the second side 42 of the metal sheet 4 as a feeding portion 34, and bends the feeding portion 34 by a first angle R1′ along a direction parallel to the third side 41′ of the metal sheet 4. In this embodiment, the first angle R1′ is equal to 90 degrees.

As shown in FIGS. 4D and 4E, step S5 defines a region formed by the third side 41′ of the metal sheet 4 and a line distant from the third side 41‘by a distance D’ as a grounding portion 33, and bends the grounding portion 33 by a second angle R2′ along a direction parallel to the third side 41′ of the metal sheet 4. In this embodiment, the distance D′ is smaller than a difference between the length D2′ of the second side of the metal sheet 4 and the length L1 of the first slit 43. In addition, the second angle R2′ is equal to 90 degrees in this embodiment.

In addition, a region formed by the feeding portion 34 and the grounding portion 33 is defined as a second radiating portion 32, and a region defined by the feeding portion 34, the grounding portion 33 and the second radiating portion 32 is defined as a first radiating portion 31.

Finally, as shown in FIG. 4F, step S6 electrically connects the grounding portion 33 and the feeding portion 34 with a base plate 35, which is opposite to the first radiating portion 31 and the second radiating portion 32. Then, the inverted-F antenna is completed. In this embodiment, the base plate 35 is disposed in parallel with the first radiating portion 31 and the second radiating portion 32.

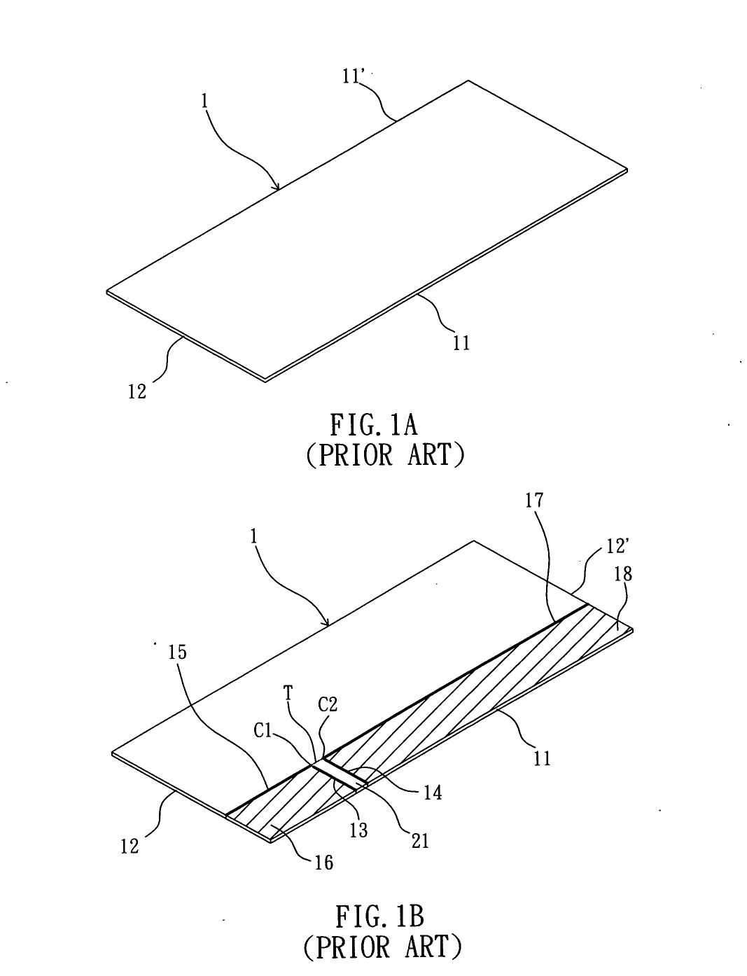

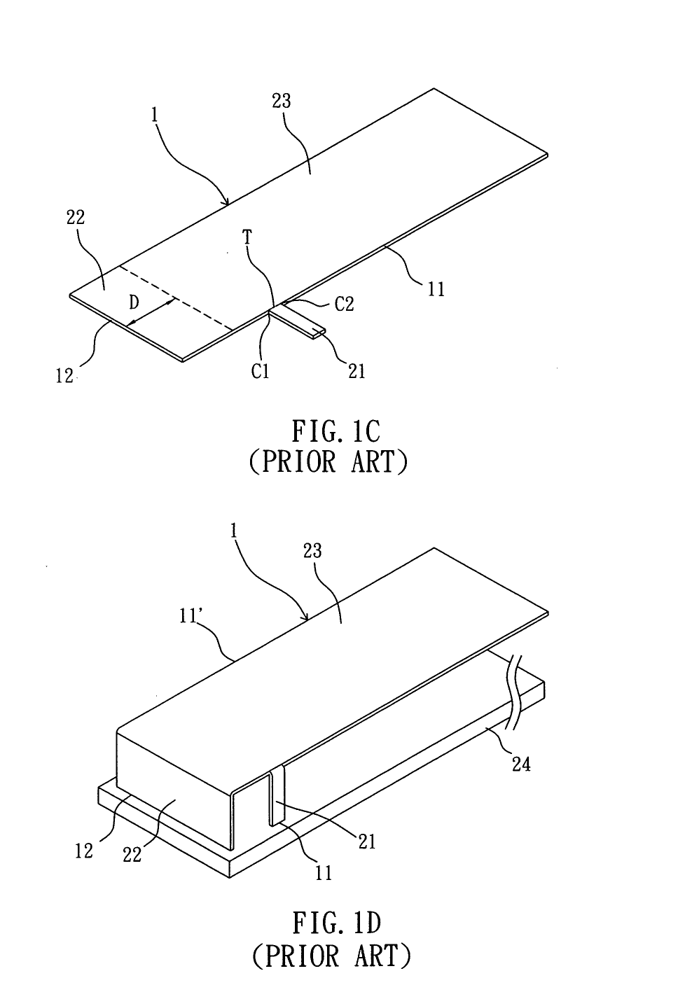

As shown in FIG. 4C, the bending portion T′ of the feeding portion 34 of the inverted-F antenna 3 only contacts one end of the first slit 43. As shown in FIG. 1B, the bending portion T of the feeding portion 21 contacts the connection portion C1 between the first slit 13 and the third slit 15 and the connection portion C2 between the second slit 14 and the fourth slit 17. Comparing FIG. 4C with FIG. 1B, the feeding portion 34 of the inverted-F antenna 3 of the invention cannot be easily damaged by the influence of cutting or bending stress, and the product yield is increased.

In summary, only two slits including the first slit and the second slit are formed in the inverted-F antenna and the manufacturing method thereof according to the invention. Compared with the prior art in which four slits are formed, the manufacturing processes of the invention are further simplified. In addition, the bending portion of the feeding portion only contacts one end of the first slit. Compared with the prior art, in which the bending portion of the feeding portion contacts the connection portion between the first slit and the third slit, and the connection portion between the second slit and the fourth slit, the feeding portion of the inverted-F antenna of the invention cannot be easily influenced by cutting or bending stress. Furthermore, the removed portion of the metal sheet of the invention occupies about 8 to 10% of the overall metal sheet. In other words, the effectively used region of the metal sheet can reach a ratio of about 90 to 92%. Compared with the prior art, in which the effectively used region only reaches a ratio of 65 to 80%, the inverted-F antenna of the invention makes more efficient use of the metal sheet.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An inverted-F antenna, comprising:
a grounding portion;
a first radiating portion extended from one side of the grounding portion;
a second radiating portion extended from the side of the grounding portion and having one side opposite to the side of the grounding portion; and
a feeding portion extended from the side of the second radiating portion.

2. The inverted-F antenna according to claim 1, wherein the first radiating portion, the second radiating portion, the grounding portion and the feeding portion are each a sheet.

3. The inverted-F antenna according to claim 1, wherein the first radiating portion, the second radiating portion, the grounding portion and the feeding portion are each a rectangle.

4. The inverted-F antenna according to claim 1, wherein the first radiating portion has a first side and the second radiating portion has a third side, and the first side is extended from the third side.

5. The inverted-F antenna according to claim 1, wherein the first radiating portion has a second side, the second radiating portion has a fourth side, and the second side and the fourth side are extended from the side of the grounding portion.

6. The inverted-F antenna according to claim 5, wherein the second side of the first radiating portion is electrically connected with the fourth side of the second radiating portion.

7. The inverted-F antenna according to claim 5, wherein a length of the fourth side is smaller than a length of the second side.

8. The inverted-F antenna according to claim 5, wherein the second side of the first radiating portion and the fourth side of the second radiating portion form an angle of 180 degrees.

9. The inverted-F antenna according to claim 1, wherein the first radiating portion and the second radiating portion form an angle with the grounding portion and are extended from the side of the grounding portion.

10. The inverted-F antenna according to claim 9, wherein the angle is 90 degrees.

11. The inverted-F antenna according to claim 1, wherein the feeding portion forms an angle with the second radiating portion and is extended from the side of the second radiating portion.

12. The inverted-F antenna according to claim 11, wherein the angle is 90 degrees.

13. The inverted-F antenna according to claim 1, further comprising:
a base plate disposed opposite to the first radiating portion and the second radiating portion and electrically connected with the grounding portion and the feeding portion.

14. The inverted-F antenna according to claim 1, which is operated in a frequency band of a GSM (Global System for Mobile communication) specification, a GPRS (General Packet Radio Service) specification, a DECT (Digital Enhanced Cordless Telecommunication) specification or an IEEE802.11 specification.

15. The inverted-F antenna according to claim 1, wherein the grounding portion, the first radiating portion, the second radiating portion, and the feeding portion are integrally formed, and are each made of metal.

16. A method of manufacturing an inverted-F antenna, comprising the steps of:
providing a metal sheet having a first side, a second side and a third side opposite to the first side;
forming a first slit from the first side of the metal sheet to the third side of the metal sheet;
forming a second slit from the second side of the metal sheet to the first slit of the metal sheet and removing a portion of the metal sheet;
defining a region, which is formed by the first slit, the second slit and the second side, as a feeding portion, and bending the feeding portion by a first angle along a direction parallel to the third side; and
defining a region, which is formed by the third side and a line distant from the third side by a distance, as a grounding portion, and bending the grounding portion by a second angle along the direction parallel to the third side.

17. The method according to claim 16, wherein the feeding portion is bent by 90 degrees along the direction parallel to the third side, and the grounding portion is bent by 90 degrees along the direction parallel to the third side.

18. The method according to claim 16, wherein a length of the first slit is smaller than a length of the second side.

19. The method according to claim 16, wherein the distance is smaller than a difference between a length of the second side and a length of the first slit.

20. The method according to claim 16, further comprising:
electrically connecting the grounding portion and the feeding portion with a base plate.
